(19) United States
(12) Patent Application Publication
(10) Pub. No.: US 2017/0117584 A1
(43) Pub. Date: Apr. 27, 2017

(54) ADDITIVE, ELECTROLYTE AND LITHIUM ION BATTERY USING THE SAME

(71) Applicants: JIANGSU HUADONG INSTITUTE OF LI-ION BATTERY CO., LTD., Jiangsu (CN); TSINGHUA UNIVERSITY, Beijing (CN)

(72) Inventors: Guan-Nan Qian, Beijing (CN); Xiang-Ming He, Beijing (CN); Yu-Ming Shang, Beijing (CN); Jian-Jun Li, Beijing (CN); Li Wang, Beijing (CN); Jian Gao, Beijing (CN); Ju-Ping Yang, Beijing (CN); Yao-Wu Wang, Beijing (CN); Peng Zhao, Beijing (CN)

(73) Assignees: JIANGSU HUADONG INSTITUTE OF LI-ION BATTERY CO., LTD., Jiangsu (CN); TSINGHUA UNIVERSITY, Beijing (CN)

(21) Appl. No.: 15/400,599

(22) Filed: Jan. 6, 2017

Related U.S. Application Data
(63) Continuation of application No. PCT/CN2015/081702, filed on Jun. 17, 2015.

(30) Foreign Application Priority Data
Jul. 9, 2014 (CN) 201410324141.9

(51) Int. Cl. H01M 10/0567; H01M 10/0525

(52) U.S. Cl. CPC H01M 10/0567; H01M 10/0525; H01M 2300/0025

(57) ABSTRACT

An additive for a lithium ion battery is disclosed. The additive is a polymer obtained by polymerizing a maleimide type monomer with an organic diamine type compound. The maleimide type monomer comprises at least one of a maleimide monomer, a bismaleimide monomer, a multimaleimide monomer and a maleimide type derivative monomer. An electrolyte liquid and a lithium ion battery are also disclosed.

### CROSS-REFERENCE TO RELATED APPLICATIONS

This application claims all benefits accruing under 35 U.S.C. §119 from China Patent Application No. 201410324141.9 , filed on Jul. 9, 2014, in the State Intellectual Property Office of China, the content of which is hereby incorporated by reference. This application is a continuation under 35 U.S.C. §120 of international patent application PCT/CN2015/081702 filed on Jun. 17, 2015 , the content of which is hereby incorporated by reference.

### FIELD

The present disclosure relates to additives, electrolytes and lithium ion batteries using the same.

### BACKGROUND

Carbonate electrolytes are one of the most widely used electrolytes in a lithium ion battery. Propylene carbonate (PC) is an ideal component of the electrolytes due to its low melting point (−55° C.), high boiling point (240° C.), high dielectric constant, and excellent ion conductivity at low temperatures. However, because PC molecules can be co-intercalated with a graphite anode during a discharge process of the lithium ion battery, it is difficult to form a stable solid electrolyte interface (SEI) on a surface of the graphite anode. The graphite material would peel off continually during the application of the lithium ion battery, and the graphite anode would be irreversibly damaged, which greatly limits the application of the propylene carbonate.

### BRIEF DESCRIPTION OF THE DRAWINGS

Implementations are described by way of example only with reference to the attached figures.

FIG. 1 is a graph showing charge and discharge curves in a first cycle of one example and one comparative example of lithium ion batteries.

FIG. 2 is a graph comparing charge and discharge cycling performances of one example and one comparative example of lithium ion batteries.

### DETAILED DESCRIPTION

A detailed description with the above drawings is made to further illustrate the present disclosure.

In one embodiment, an additive for a lithium ion battery is provided. The additive is a polymer obtained by polymerizing a maleimide type monomer with an organic diamine type compound.

The maleimide type monomer comprises at least one of a maleimide monomer, a bismaleimide monomer, a multimaleimide monomer, and a maleimide type derivative monomer.

The maleimide monomer can be represented by formula I:

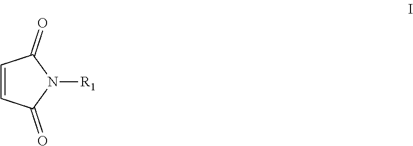

wherein R₁ is a monovalent organic substituent. More specifically, R₁ can be —R, —RNH₂R, —C(O)CH₃, —CH₂OCH₃, —CH₂S(O)CH₃, a monovalent alicyclic group, a monovalent substituted aromatic group, or a monovalent unsubstituted aromatic group, such as —C₆H₅, —C₆H₄C₆H₅, or —CH₂(C₆H₄)CH₃. R can be a hydrocarbyl with 1 to 6 carbon atoms, such as an alkyl with 1 to 6 carbon atoms. An atom, such as hydrogen, of the monovalent aromatic group can be substituted by a halogen, an alkyl with 1 to 6 carbon atoms, or a silane group with 1 to 6 carbon atoms to form the monovalent substituted aromatic group. The monovalent unsubstituted aromatic group can be phenyl, methyl phenyl, or dimethyl phenyl. An amount of benzene ring in the monovalent substituted aromatic group or the monovalent unsubstituted aromatic group can be 1 to 2.

The maleimide monomer can be selected from N-phenyl-maleimide, N-(p-methyl-phenyl)-maleimide, N-(m-methyl-phenyl)-maleimide, N-(o-methyl-phenyl)-maleimide, N-cyclohexane-maleimide, maleimide, maleimide-phenol, maleimide-benzocyclobutene, di-methylphenyl-maleimide, N-methyl-maleimide, ethenyl-maleimide, thio-maleimide, keto-maleimide, methylene-maleimide, maleimide-methyl-ether, maleimide-ethanediol, 4-aleimide-phenyl sulfone, and combinations thereof.

The bismaleimide monomer can be represented by formula II:

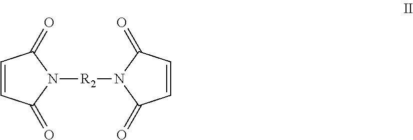

wherein R₂ is a bivalent organic substituent. More specifically, R₂ can be —R—, —RNH₂R—, —C(O)CH₂—, —CH₂OCH₂—, —C(O)—, —O—, —O—O—, —S—, —S—S—, —S(O)—, —CH₂S(O)CH₂—, —(O)S(O)—, —R—Si(CH₃)₂—O—Si(CH₃)₂—R—, a bivalent alicyclic group, a bivalent substituted aromatic group, or a bivalent unsubstituted aromatic group, such as phenylene (—C₆H₄—), diphenylene (—C₆H₄C₆H₄—), substituted phenylene, substituted diphenylene, —(C₆H₄)—R₅—(C₆H₄)—, —CH₂(C₆H₄)CH₂—, or —CH₂(C₆H₄)(O)—. R₅ can be —CH₂—, —C(O)—, —C(CH₃)₂—, —O—, —O—O—, —S—, —S—S—,—S(O)— or —(O)S(O)—. R can be the hydrocarbyl with 1 to 6 carbon atoms, such as the alkyl with 1 to 6 carbon atoms. An atom, such as hydrogen, of the bivalent aromatic group can be substituted by the halogen, an alkyl with 1 to 6 carbon atoms, or a silane group with 1 to 6 carbon atoms to form the bivalent substituted aromatic group. An amount of benzene ring in the bivalent substituted aromatic group or the bivalent unsubstituted aromatic group can be 1 to 2.

The bismaleimide monomer can be selected from
N,N′-bismaleimide-4,4′-diphenyl-methane,
1,1′-(methylene-di-4,1-phenylene)-bismaleimide,
N,N′-(1,1′-diphenyl-4,4′-dimethylene)-bismaleimide,
N,N′-(4-methyl-1,3-phenylene)-bismaleimide,
1,1′-(3,3′-dimethyl-1,1′-diphenyl-4,4′-dimethylene)-bismaleimide,
N,N′-ethenyl-bismaleimide, N,N′-butenyl-bismaleimide,
N,N′-(1,2-phenylene)-bismaleimide, N,N′-(1,3-phenylene)-bismaleimide,
N,N′-bismaleimide sulfide, N,N′-bismaleimide disulfide, keto-N,N′-bismaleimide,
N,N′-methylene-bismaleimide, bismaleimide-methyl-ether, 1,2-bismaleimide-1,2-glycol,
N,N′-4,4′-diphenyl-ether-bismaleimide, 4,4-bismaleimide-diphenyl sulfone and combinations thereof.

The maleimide type derivative monomer can be obtained by substituting a hydrogen atom of the maleimide monomer, the bismaleimide monomer, or the multimaleimide monomer with a halogen atom.

The organic diamine type compound can be represented by formula III or formula IV:

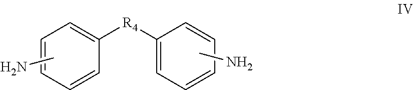

wherein R₃ is a bivalent organic substituent, and R₄ is a another bivalent organic substituent.

R₃ can be —(CH₂)ₙ—, —CH₂-O—CH₂—, —CH(NH)—(CH₂)ₙ—, a bivalent alicyclic group, a bivalent substituted aromatic group, or a bivalent unsubstituted aromatic group, such as phenylene(—C₆H₄—), diphenylene(—C₆H₄C₆H₄—), the substituted phenylene, or the substituted diphenylene. R₄ can be —(CH₂)ₙ—, —O—, —S—, —S—S—, —CH₂—O—CH₂—, —CH(NH)—(CH₂)ₙ—, or —CH(CN)(CH₂)ₙ—. n can be 1 to 12. An atom, such as hydrogen, of the bivalent aromatic group can be substituted by the halogen, an alkyl with 1 to 6 carbon atoms, or a silane group with 1 to 6 carbon atoms to form the bivalent substituted aromatic group. An amount of the benzene ring in the bivalent substituted aromatic group or the bivalent unsubstituted aromatic group can be preferably 1 to 2.

The organic diamine type compound can comprise, but not limited to, ethylenediamine, phenylenediamine, diamino-diphenyl-methane, diamino-diphenyl-ether, or combinations thereof.

A molecular weight of the polymer can range between about 1000 to about 500000.

In one embodiment, the maleimide type monomer is bismaleimide, the organic diamine type compound is diamino-diphenyl-methane, and the additive is represented by formula V below:

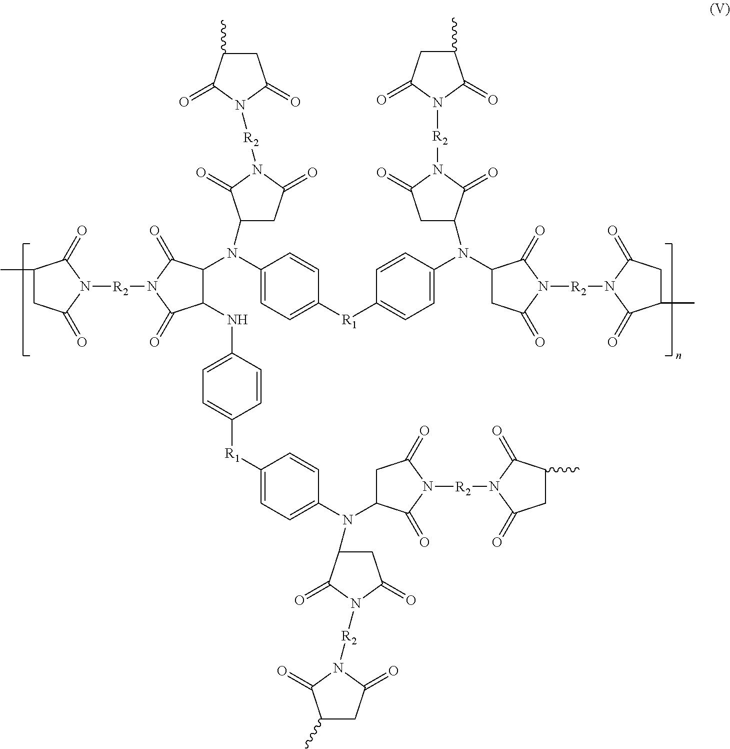

In one embodiment, a method for preparing the additive comprises:

S1, mixing the maleimide type monomer with a solvent in a mass ratio of (0.01 to 1):1 to form a first solution of the maleimide type monomer, wherein the mass ratio of the maleimide type monomer to the solvent can be (0.1 to 0.5):1;

S2, heating the first solution of the maleimide type monomer to a temperature of about 30□ to about 180□, such as about 50□ to about 150□; and

S3, mixing and stirring a second solution of the organic diamine type compound and the first solution of the maleimide type monomer to react, and obtaining the polymer, which is the additive.

A molar ratio of the maleimide type monomer to the organic diamine type compound can be (0.1 to 10):1, such as (0.5 to 4):1. The second solution of the organic diamine type compound can be obtained previously by dissolving the organic diamine type compound in a solvent. A mass ratio of the organic diamine type compound to the solvent can be (0.1 to 10):1, such as (0.1 to 0.5):1

In the step S3, the second solution of the organic diamine type compound can be transported into the first solution of the maleimide type monomer at a set rate via a delivery pump, and then stirred continuously for a set time to react adequately. The set time can be in a range from about 0.5 hour (“h”) h to about 48 h, such as from about 1 h to about 24 h. The solvent can be an organic solvent that dissolves the maleimide type monomer and the organic diamine type compound, such as gamma-butyrolactone, propylene carbonate, or N-methyl pyrrolidone (NMP).

In one embodiment, an electrolyte liquid is provided. The electrolyte liquid comprises an electrolyte salt, a non-aqueous solvent, and the additive. The electrolyte salt and the additive can be dissolved in the non-aqueous solvent. A mass-volume concentration of the additive in the electrolyte liquid can be about 0.01% (mass-volume concentration, w/v) to about 10% (w/v), such as about 0.1% (w/v) to about 5% (w/v).

The electrolyte salt and the non-aqueous solvent can be selected according to the application of the electrolyte liquid.

The non-aqueous solvent can comprise at least one of cyclic carbonates, chain carbonates, cyclic ethers, chain ethers, nitriles, amides and combinations thereof, such as ethylene carbonate, diethyl carbonate, propylene carbonate, dimethyl carbonate, ethyl methyl carbonate, butylene carbonate, gamma-butyrolactone, gamma-valerolactone, dipropyl carbonate, N-methyl pyrrolidone, N-methylformamide, N-methylacetamide, N,N-dimethylformamide, N,N-diethylformamide, diethyl ether, acetonitrile, propionitrile, anisole, succinonitrile, adiponitrile, glutaronitrile, dimethyl sulfoxide, dimethyl sulfite, vinylene carbonate, ethyl methyl carbonate, dimethyl carbonate, diethyl carbonate, fluoroethylene carbonate, chloropropylene carbonate, acetonitrile, succinonitrile, methoxymethylsulfone, tetrahydrofuran, 2-methyltetrahydrofuran, epoxy propane, methyl acetate, ethyl acetate, propyl acetate, methyl butyrate, ethyl propionate, methyl propionate, 1,3-dioxolane, 1,2-diethoxyethane, 1,2-dimethoxyethane, and 1,2-dibutoxy.

The electrolyte salt can be a lithium salt that comprises but is not limited to at least one of lithium chloride (LiCl), lithium hexafluorophosphate (LiPF₆), lithium tetrafluoroborate (LiBF₄), lithium methanesulfonate (LiCH₃SO), lithium trifluoromethanesulfonate (LiCF₃SO₃), lithium hexafluoroarsenate (LiAsF₆), lithium hexafluoroantimonate (LiSbF₆), lithium perchlorate (LiClO₄), Li[BF₂(C₂O₄)], Li[PF₂(C₂O₄)₂], Li[N(CF₃SO₂)₂], Li[C(CF₃SO₂)₃], and lithium bisoxalatoborate (LiBOB).

In one embodiment, an electrochemical battery is provided. The electrochemical battery comprises a cathode, an anode, a separator, and the electrolyte liquid. The cathode and the anode are spaced from each other by the separator. The cathode can further comprise a cathode current collector and a cathode material layer located on a surface of the cathode current collector. The anode can further comprise an anode current collector and an anode material layer located on a surface of the anode current collector. The cathode material layer and the anode material layer are arranged and spaced by the separator.

When the electrochemical battery is a lithium ion battery, the cathode material layer can comprise a cathode active material. The cathode active material can be at least one of layer type lithium transition metal oxides, spinel type lithium transition metal oxides, and olivine type lithium transition metal oxides, such as olivine type lithium iron phosphate, layer type lithium cobalt oxide, layer type lithium manganese oxide, spinel type lithium manganese oxide, lithium nickel manganese oxide, and lithium cobalt nickel manganese oxide. The anode material layer can comprise an anode active material, such as at least one of lithium titanate, graphite, mesophase carbon micro beads (MCMB), acetylene black, mesocarbon miocrobead, carbon fibers, carbon nanotubes, and cracked carbon.

The cathode material layer and the anode material layer can respectively comprise a conducting agent and a binder. The conducting agent can be carbonaceous materials, such as at least one of carbon black, conducting polymers, acetylene black, carbon fibers, carbon nanotubes, and graphite. The binder can be at least one of polyvinylidene fluoride (PVDF), polyvinylidene fluoride, polytetrafluoroethylene (PTFE), fluoro rubber, ethylene oropylene diene monomer, and styrene-butadiene rubber (SBR).

The separator can be a polyolefin microporous membrane, modified polypropylene fabric, polyethylene fabric, glass fiber fabric, superfine glass fiber paper, vinylon fabric, or composite membrane of nylon fabric, and wettable polyolefin microporous membrane composited by welding or bonding.

### EXAMPLES

### Example 1

The preparation of the additive includes dissolving 4 grams (“g”) of bismaleimide and 2.207 g of diamino-diphenyl-methane in the NMP to form a solution. The oxygen is removed from the solution. The solution is heated to 130° C. and the reaction is carried out for 6 hours. After cooling, the additive represented by formula V is obtained in steps of precipitation using ethyl alcohol, washing and drying.

The additive is added in the electrolyte liquid of the lithium ion battery. More specifically, 1 mol/L of LiPF₆ is dissolved in a solvent mixture of propylene carbonate and diethyl carbonate to obtain the electrolyte liquid, wherein a volume ratio of the propylene carbonate and the diethyl carbonate is 3:2. 1% (w/v) of the additive is added to the electrolyte liquid. The lithium ion battery having the lithium metal as the cathode and the graphite as the anode is assembled. The lithium ion battery is charged and discharged at 0.2 C constant current in the voltage range between 0.01V to 2V.

### Comparative Example 1

The lithium ion battery is assembled and then charged and discharged under the same conditions as in Example 1 except that there is no additive added in the electrolyte liquid.

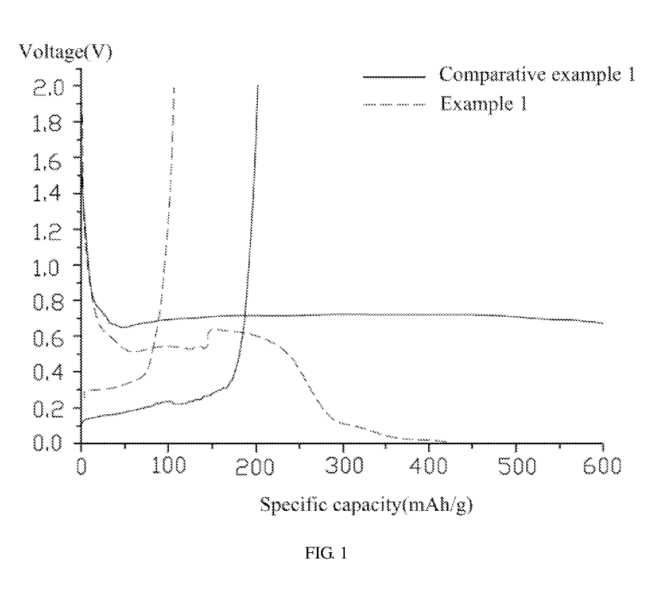

FIG. 1 is a graph showing charge and discharge curves in a first cycle of example 1 and comparative example 1 of lithium ion batteries. It can be seen from FIG. 1 that a voltage platform is emerged at about 0.7V in the charge and discharge curves in the first cycle of the lithium ion battery without the additive, which demonstrates that PC is co-intercalated with the graphite seriously, thereby the graphite anode is peeled off to cause irreversible damage. Meanwhile a voltage of the charge and discharge in the first cycle of the lithium ion battery adding the additive is rapidly falling to about 0V, and the voltage platform demonstrating that PC being co-intercalated with the graphite (about 0.7V) is shorter. It can thus be concluded that the additive decreases the co-intercalation effects between PC and graphite.

### Example 2

The additive is the same as in Example 1 and added in the electrolyte liquid of the lithium ion battery. More specifically, 1.2 mol/L of LiPF₆ is dissolved in a solvent mixture of propylene carbonate and diethyl carbonate to obtain the electrolyte liquid, wherein the volume ratio of the propylene carbonate and the diethyl carbonate is 2:2. 1% (w/v) of the additive is added to the electrolyte liquid. The lithium ion battery having the lithium metal as the cathode and the graphite as the anode is assembled. The lithium ion battery is charged and discharged at 0.2 C constant current in the voltage range between 0.01V to 2V.

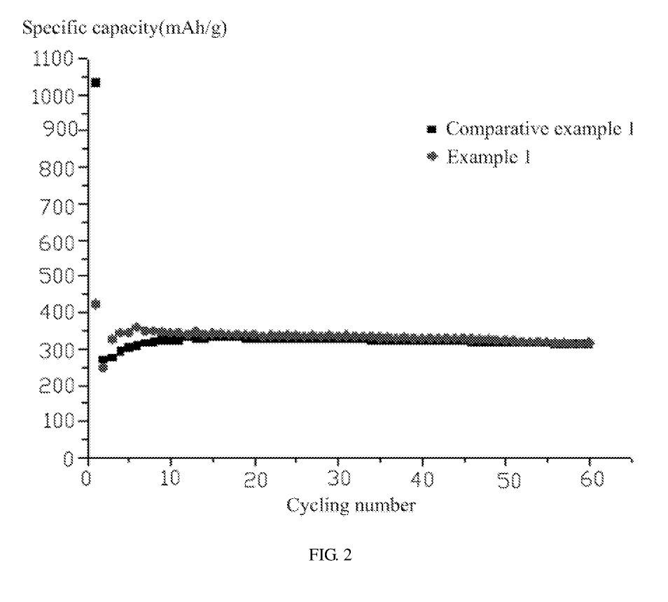

FIG. 2 is a graph comparing charge and discharge cycling performances of example 1 and comparative example 1 of lithium ion batteries. It can be seen from FIG. 2 that by adding the additive, the co-intercalation effects between PC and graphite is decreased, and a discharge specific capacity of the lithium ion battery after 60 cycles reaches about 314 mAh/g equal or even higher than comparative example 1. It can thus be concluded that addition of the additive would not have negative effects on the cycling performances of the lithium ion battery.

### Example 3

The preparation of the additive includes dissolving 3.2 g of N-phenyl-maleimide and 2.34 g of diamino-diphenyl-methane in the NMP to form a solution. The oxygen is removed from the solution. The solution is then heated to 130° C. and the reaction is carried out for 8 hours. After cooling, the additive is obtained by precipitation processes using ethyl alcohol, washing, and drying.

The additive is added in the electrolyte liquid of the lithium ion battery. The lithium ion battery is assembled and cycled under the same conditions as in Example 1. The test result shows that by adding the additive in the electrolyte liquid of the lithium ion battery, the co-intercalation effects between the PC and the graphite is decreased, and the discharge specific capacity of the lithium ion battery after 60 cycles reaches about 312 mAh/g.

### Example 4

The preparation of the additive includes dissolving 4 g of N,N′-ethenyl-bismaleimide and 2.75 g of diamino-diphenyl-methane in the NMP to form a solution. The oxygen is removed from the solution. The solution is then heated to 130° C. and the reaction is carried out for 7 hours. After cooling, the additive represented by formula V is obtained in steps of precipitation using ethyl alcohol, washing and drying.

The additive is added in the electrolyte liquid of the lithium ion battery. The lithium ion battery is assembled and cycled under the same conditions as in Example 1. The test result shows that by adding the additive in the electrolyte liquid of the lithium ion battery, the co-intercalation effects between the PC and the graphite is decreased, and the discharge specific capacity of the lithium ion battery after 60 cycles reaches about 311 mAh/g.

### Example 5

The preparation of the additive includes dissolving 4.75 g of bismaleimide represented by formula VI and 2.75 g of diamino-diphenyl-ether in the NMP to form a solution. The oxygen is removed from the solution. The solution is then heated to 155° C. and the reaction is carried out for 6 hours. After cooling, the additive is obtained in steps of precipitation using ethyl alcohol, washing and drying.

The additive is added in the electrolyte liquid of the lithium ion battery. The lithium ion battery is assembled and cycled under the same conditions as in Example 1. The test result shows that by adding the additive in the electrolyte liquid of the lithium ion battery, the co-intercalation effects between the PC and the graphite are decreased, and the discharge specific capacity of the lithium ion battery after 60 cycles reaches about 317 mAh/g.

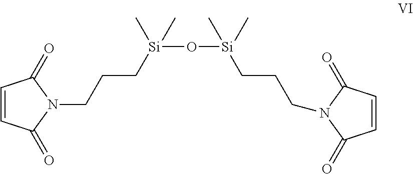 [SMILES: C[Si](C)(CCCN1C(=O)C=CC1=O)O[Si](C)(C)CCCN1C(=O)C=CC1=O]

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. An additive for a lithium ion battery, the additive being a polymer obtained by polymerizing a maleimide type monomer with an organic diamine type compound,
wherein the maleimide type monomer is selected from the group consisting of maleimide monomer, bismaleimide monomer, multimaleimide monomer, maleimide type derivative monomer, and combinations thereof; and
the organic diamine type compound is represented by formula III or formula IV: 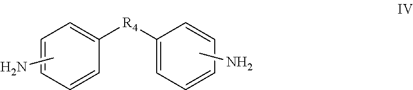
wherein R₃ is a bivalent organic substituent and R₄ is another bivalent organic substituent.

2. The additive of claim 1, wherein R₃ is selected from the group consisting of —(CH₂)ₙ—, —CH₂—O—CH₂—, —CH(NH)—(CH₂)ₙ—, phenylene, diphenylene, substituted phenylene, substituted diphenylene, and bivalent alicyclic group, R₄ is selected from the group consisting of —(CH₂)ₙ—, —O—, —S—, —S—S—, —CH₂—O—CH₂—, —CH(NH)—(CH₂)ₙ—, and —CH(CN)(CH₂)ₙ—, and n=1 to 12.

3. The additive of claim 1, wherein the organic diamine type compound is selected from the group consisting of ethylenediamine, phenylenediamine, diamino-diphenyl-methane, diamino-diphenyl-ether, and combinations thereof.

4. The additive of claim 1, wherein the maleimide monomer is represented by formula I: 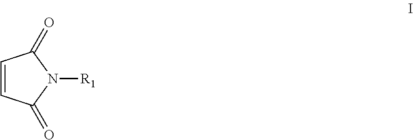
wherein R₁ is a monovalent organic substitute.

5. The additive of claim 4, wherein R₁ is selected from the group consisting of —R, —RNH₂R, —C(O)CH₃, —CH₂OCH₃, —CH₂S(O)CH₃, —C₆H₅, —C₆H₄C₆H₅, —CH₂(C₆H₄)CH₃, and monovalent alicyclic group; R is hydrocarbyl with 1 to 6 carbon atoms.

6. The additive of claim 1, wherein the maleimide monomer is selected from the group consisting of N-phenyl-maleimide, N-(p-methyl-phenyl)-maleimide, N-(m-methyl-phenyl)-maleimide, N-(o-methyl-phenyl)-maleimide, N-cyclohexane-maleimide, maleimide, maleimide-phenol, maleimide-benzocyclobutene, di-methylphenyl-maleimide, N-methyl-maleimide, ethenyl-maleimide, thio-maleimide, keto-maleimide, methylene-maleimide, maleimide-methyl-ether, maleimide-ethanediol, 4-maleimide-phenyl sulfone, and combinations thereof.

7. The additive of claim 1, wherein the bismaleimide monomer is represented by formula II: 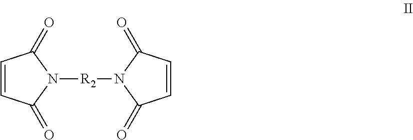
wherein R₂ is a bivalent organic substitute.

8. The additive of claim 7, wherein R₂ is selected from the group consisting of —R—, —RNH₂R—, —C(O)CH₂—, —CH₂OCH₂—, —C(O)—, —O—, —O—O —, —S—, —S—S—, —S(O)—, —CH₂S(O)CH₂—, —(O)S(O)—, —CH₂(C₆H₄)CH₂—, —CH₂(C₆H₄)(O)—, —R—Si(CH₃)₂—O—Si(CH₃)₂—R—, —C₆H₄—, —C₆H₄C₆H₄—, bivalent alicyclic group or —(C₆H₄)—R₅—(C₆H₄)—; R₅ is —CH₂—, —C(O)—, —C(CH₃)₂—, —O—,—O—O—, —S—, —S—S—, —S(O)—, and —(O)S(O)—; and R is hydrocarbyl with 1 to 6 carbon atoms.

9. The additive of claim 1, wherein the bismaleimide monomer is selected from the group consisting of N,N′-bismaleimide-4,4′-diphenyl-methane, 1,1′-(methylene-di-4,1-phenylene)-bismaleimide, N,N′-(1,1′-diphenyl-4,4′-dimethylene)-bismaleimide, N,N′-(4-methyl-1,3-phenylene)-bismaleimide, 1,1′-(3,3′-dimethyl-1,1′-diphenyl-4,4′-dimethylene)-bismaleimide, N,N′-ethenyl-bismaleimide, N,N′-butenyl-bismaleimide, N,N′-(1,2-phenylene)-bismaleimide, N,N′-(1,3-phenylene)-bismaleimide, N,N′-bismaleimide sulfide, N,N′-bismaleimide disulfide, keto-N,N′-bismaleimide, N,N′-methylene-bismaleimide, bismaleimide-methyl-ether, 1,2-bismaleimide-1,2-glycol, N,N′-4,4′-diphenyl-ether-bismaleimide, 4,4′-bismaleimide-diphenyl sulfone and combinations thereof.

10. The additive of claim 1, wherein a molar ratio of the maleimide type monomer to the organic diamine type compound is (0.5 to 4):1.

11. The additive of claim 1, wherein a molecular weight of the polymer is in a range from about 1000 to about 500000.

12. An electrolyte liquid comprising an electrolyte salt, a non-aqueous solvent, and an additive, wherein the additive is a polymer obtained by polymerizing of a maleimide type monomer with an organic diamine type compound;
the maleimide type monomer is selected from the group consisting of a maleimide monomer, a bismaleimide monomer, a multimaleimide monomer, a maleimide type derivative monomer, and combinations thereof;
the organic diamine type compound is represented by formula III or formula IV: 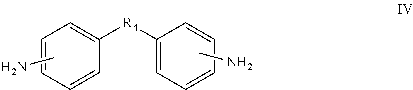
wherein R₃ is a bivalent organic substituent and R₄ is another bivalent organic substituent;
the non-aqueous solvent comprises propylene carbonate.

13. The electrolyte liquid of claim 12, wherein a mass-volume concentration of the additive in the electrolyte liquid is about 0.01% to about 10%.

14. The electrolyte liquid of claim 12, wherein the non-aqueous solvent further comprises at least one of ethylene carbonate, diethyl carbonate, propylene carbonate, dimethyl carbonate, ethyl methyl carbonate, butylene carbonate, gamma-butyrolactone, gamma-valerolactone, dipropyl carbonate, N-methyl pyrrolidone, N-methylformamide, N-methylacetamide, N,N-dimethylformamide, N,N-diethylformamide, diethyl ether, acetonitrile, propionitrile, anisole, succinonitrile, adiponitrile, glutaronitrile, dimethyl sulfoxide, dimethyl sulfite, vinylene carbonate, ethyl methyl carbonate, dimethyl carbonate, diethyl carbonate, fluoroethylene carbonate, chloropropylene carbonate, acetonitrile, succinonitrile, methoxymethylsulfone, tetrahydrofuran, 2-methyltetrahydrofuran, epoxy propane, methyl acetate, ethyl acetate, propyl acetate, methyl butyrate, ethyl propionate, methyl propionate, 1,3-dioxolane, 1,2-diethoxyethane, 1,2-dimethoxyethane, and 1,2-dibutoxy.

15. The electrolyte liquid of claim 12, wherein the electrolyte salt is selected from the group consisting of lithium chloride, lithium hexafluorophosphate, lithium tetrafluoroborate, lithium methanesulfonate, lithium trifluoromethanesulfonate, lithium hexafluoroarsenate, lithium hexafluoroantimonate, lithium perchlorate, Li[BF₂(C₂O₄)], Li[PF₂(C₂O₄)₂], Li[N(CF₃SO₂)₂], Li[C(CF₃SO₂)₃], lithium bisoxalatoborate (LiBOB), and combinations thereof.

16. A lithium ion battery comprising a cathode, an anode, a separator, and an electrolyte liquid, wherein the electrolyte liquid comprising an electrolyte salt, a non-aqueous solvent, and an additive;
the additive is a polymer obtained by polymerizing of a maleimide type monomer with an organic diamine type compound;
the maleimide type monomer is selected from the group consisting of a maleimide monomer, a bismaleimide monomer, a multimaleimide monomer, a maleimide type derivative monomer, and combinations thereof;
the organic diamine type compound is represented by formula III or formula IV:
H₂N—R₃—NH₂ III 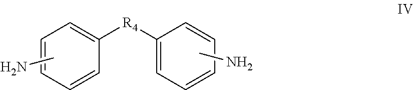
wherein R₃ is a bivalent organic substituent and R₄ is another bivalent organic substituent;
the non-aqueous solvent comprises propylene carbonate.
